(19) United States
(12) Patent Application Publication
(10) Pub. No.: US 2026/0075575 A1
(43) Pub. Date: Mar. 12, 2026

(54) METHOD FOR WIRELESS COMMUNICATION AND TERMINAL DEVICE

(71) Applicant: GUANGDONG OPPO MOBILE TELECOMMUNICATIONS CORP., LTD., Dongguan (CN)

(72) Inventors: Yang LIU, Dongguan (CN); Xinlei YU, Dongguan (CN); Qianxi LU, Dongguan (CN)

(21) Appl. No.: 19/394,598

(22) Filed: Nov. 19, 2025

Related U.S. Application Data
(63) Continuation of application No. PCT/CN2023/117930, filed on Sep. 11, 2023.

(51) Int. Cl. H04W 64/00; H04B 17/318

(52) U.S. Cl. CPC H04W 64/00; H04B 17/328

(57) ABSTRACT

A method for wireless communication includes: a terminal device determines whether to perform relaxed positioning measurement based on first information, the first information being associated with one or more of the following: a signal quality of a synchronization signal block (SSB) of a serving cell; and a signal quality of a neighbor cell.

### CROSS-REFERENCE TO RELATED APPLICATION

This application is a Continuation Application of International Application No. PCT/CN2023/117930 filed on Sep. 11, 2023, which is incorporated herein by reference in its entirety.

### TECHNICAL FIELD

The present disclosure relates to the field of communication technologies, and in particular, to a method for wireless communication and a terminal device.

### BACKGROUND

In order to reduce the power consumption of the terminal device, the terminal device may perform relaxed positioning measurement in a case where related relaxed measurement criteria (e.g., low mobility criterion) are met. Generally, the relaxed measurement criterion is associated with a signal quality of a serving cell of the terminal device, however, in some cases, the signal quality of the serving cell cannot accurately reflect the mobility state of the terminal device.

### SUMMARY

The present disclosure provides a method for wireless communication and a terminal device. The following is an introduction to various aspects involved in the present disclosure.

In a first aspect, a method for wireless communication is provided, and includes: determining, by a terminal device, whether to perform relaxed positioning measurement based on first information; where the first information is associated with one or more of: a signal quality of a synchronization signal block (SSB) of a serving cell; and a signal quality of a neighbor cell.

In a second aspect, a terminal device is provided, and includes: a determining unit, configured to determine whether to perform relaxed positioning measurement based on first information; where the first information is associated with one or more of: a signal quality of a synchronization signal block (SSB) of a serving cell; and a signal quality of a neighbor cell.

In a third aspect, a terminal device is provided, and includes a processor, a memory, and a communication interface, where the memory is configured to store one or more computer programs, and the processor is configured to call the computer program in the memory to enable the terminal device to perform some or all of the steps of the method in the first aspect.

In a fourth aspect, embodiments of the present disclosure provide a communication system, and the system includes the above-mentioned terminal device. In another possible design, the system may further include other devices that interact with the terminal device in the solutions provided in the embodiments of the present disclosure.

In a fifth aspect, embodiments of the present disclosure provide a non-transitory computer-readable storage medium, where the non-transitory computer-readable storage medium stores a computer program, and the computer program enables a terminal to perform some or all of the steps of the method in the first aspect above.

In a sixth aspect, embodiments of the present disclosure provide a computer program product, where the computer program product includes a non-transitory computer-readable storage medium storing a computer program, and the computer program is operable to enable a terminal to perform some or all of the steps of the method in the first aspect above. In some implementations, the computer program product may be a software installation package.

In a seventh aspect, a computer program is provided, where the computer program enables a computer to perform the method in the first aspect.

In an eighth aspect, embodiments of the present disclosure provide a chip, and the chip includes a memory and a processor, where the processor may call and run a computer program from the memory to implement some or all of the steps described in the method in the first aspect above.

### BRIEF DESCRIPTION OF THE DRAWINGS

FIG. 1 is a wireless communication system 100 applied to the embodiments of the present disclosure.

FIG. 2 is an example diagram of a time difference of arrival (TDOA) positioning method.

FIG. 3 is an example diagram of beam sweeping.

FIG. 4 is an example diagram of a mobility state of a terminal device.

FIG. 5 is a schematic flowchart of a method for wireless communication in the embodiments of the present disclosure.

FIG. 6 is an example diagram of a position relationship between the terminal device in FIG. 4 and an SSB0 beam.

FIG. 7 is a schematic diagram of a position relationship between the terminal device in FIG. 4, a serving cell, and a neighbor cell.

FIG. 8 is a schematic flowchart of another method for wireless communication in the embodiments of the present disclosure.

FIG. 9 is a schematic diagram of a change in a signal quality of an SSB of a serving cell provided in the embodiments of the present disclosure.

FIG. 10 is a schematic diagram of changes in signal qualities of a serving cell and a neighbor cell provided in the embodiments of the present disclosure.

FIG. 11 is a schematic diagram of a terminal device in the embodiments of the present disclosure.

FIG. 12 is a schematic structural diagram of a communication apparatus in the embodiments of the present disclosure.

### DETAILED DESCRIPTION

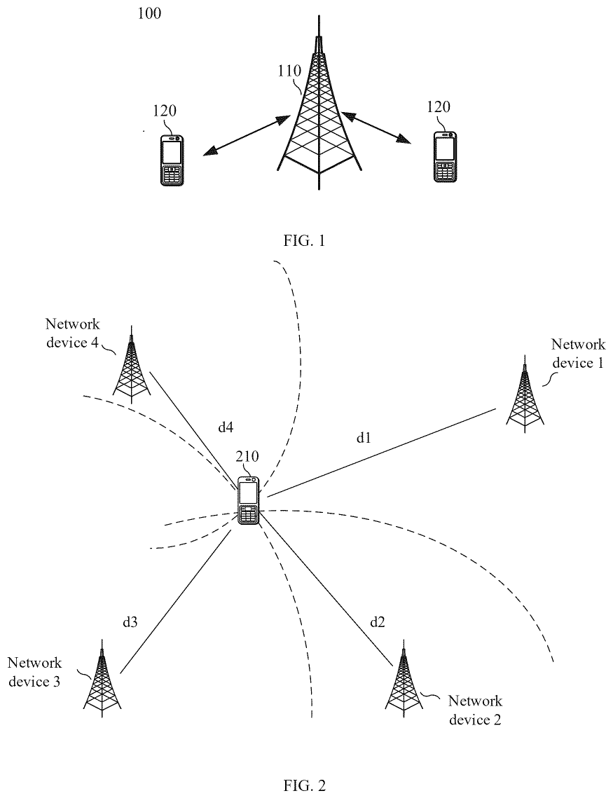

The technical solutions in the present disclosure will be described below with reference to the drawings. To facilitate understanding of the present disclosure, a communication system applicable to the embodiments of the present disclosure is described below in conjunction with FIG. 1.

FIG. 1 is a wireless communication system 100 applied to the embodiments of the present disclosure. The wireless communication system 100 may include a network device 110 and terminal devices 120. The network device 110 may be a device that communicates with the terminal device 120. The network device 110 may provide a communication coverage for a specific geographical area, and may communicate with the terminal device 120 located within the coverage area.

FIG. 1 exemplarily illustrates a network device and two terminals, and optionally, the wireless communication system 100 may include multiple network devices, and there may be other numbers of terminal devices included within a coverage area of each network device, which is not limited in the embodiments of the present disclosure.

Optionally, the wireless communication system 100 may further include other network entities such as a network controller and a mobility management entity, etc., which is not limited in the embodiments of the present disclosure.

It should be understood that the technical solutions of the embodiments of the present disclosure may be applied to various communication systems, such as: a 5th generation (5G) system or a new radio (NR), a long term evolution (LTE) system, an LTE frequency division duplex (FDD) system, an LTE time division duplex (TDD), and the like. The technical solutions provided in the present disclosure may further be applied to future communication systems, e.g., a 6th generation mobile communication system, or a satellite communication system, etc.

The terminal device in the embodiments of the present disclosure may also be referred to as a user equipment (UE), an access terminal, a user unit, a user station, a mobile platform, a mobile station (MS), a mobile terminal (MT), a remote station, a remote terminal, a mobile device, a user terminal, a terminal, a wireless communication device, a user agent or a user apparatus. The terminal device in the embodiments of the present disclosure may be a device that provides voice and/or data connectivity to users and may be used to connect people, objects and machines, such as a handheld device, a vehicle-mounted device or the like with wireless connection functions. The terminal device in the embodiments of the present disclosure may be a mobile phone, a pad, a laptop computer, a palm computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, the UE may be configured to act as a base station. For example, a UE may act as a scheduling entity that provides sidelink signals between UEs in V2X or D2D, etc. For example, a cellular phone and a car communicate with each other using sidelink signals. A cellular phone and a smart home device communicate with each other without relaying a communication signal through a base station.

The network device in the embodiments of the present disclosure may be a device for communicating with the terminal device, and the network device may also be referred to as an access network device or a wireless access network device, and for example, the network device may be a base station. The network device in the embodiments of the present disclosure may refer to a radio access network (RAN) node (or device) that connects a terminal device to a wireless network. The term “base station” may broadly cover or be replaced by the following names, such as: NodeB, evolved base station (evolved NodeB, eNB), next generation base station (next generation NodeB, gNB), relay station, access point, transmission point (transmitting and receiving point, TRP), transmitting point (TP), master station (MeNB), secondary station (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node or the like. The base station may be a macro base station, a micro base station, a relay node, a donor node, or the like, or a combination thereof. The base station may further refer to a communication module, modem or chip configured in the aforementioned devices or apparatuses. The base station may further be a mobile switching center, a device that performs a base station function in device-to-device (D2D), vehicle-to-everything (V2X), and machine-to-machine (M2M) communications, a network side device in a 6G network, or a device that performs a base station function in future communication systems, etc. The base station may support networks with the same or different access technologies. The embodiments of the present disclosure do not limit the specific technology and specific device form used by the network device.

The base station may be fixed, or may be mobile. For example, a helicopter or drone may be configured to act as a mobile base station, and one or more cells may move according to the position of the mobile base station. In other examples, a helicopter or drone may be configured to act as a device communicating with another base station.

In some deployments, the network device in the embodiments of the present disclosure may refer to a CU or a DU, or the network device includes a CU and a DU. The gNB may further include an AAU.

The network device and the terminal device may be deployed on land, including indoors or outdoors, handheld or vehicle-mounted; they may also be deployed on the water; and they may further be deployed on aircraft, balloons and satellites in the air. The embodiments of the present disclosure do not limit the scenarios in which the network devices and terminal devices are located.

It should be understood that some or part of the functions of the communication device in the present disclosure may also be implemented through software functions running on hardware, or implemented through virtualization functions instantiated on a platform (e.g., a cloud platform).

For ease of understanding, the communication process involved in the embodiments of the present disclosure is described below.

### Traditional Positioning

Generally, positioning technologies may be based on time of arrival, time difference of arrival (TDOA), received signal strength, and angle-of-arrival (AOA), etc.

TDOA is a method for positioning by using the time difference of arrival, also referred to as hyperbolic positioning. The TDOA algorithm does not directly use the signal arrival time, but uses the time difference between multiple base stations receiving signals, to determine a position of a mobile target.

The TDOA positioning requires time synchronization between the respective network devices participating in the positioning. When uplink positioning is applied, the terminal device may transmit an uplink sounding reference signal (SRS), each network device needs to measure the reference signal transmitted from the terminal device, to determine the path difference of signals from the terminal device to different network devices. The intersection point of the hyperbolas formed by more than two unrelated path difference results is the positioning result. When downlink positioning is applied, each network device transmits a downlink positioning reference signal (DL-PRS), and the terminal device needs to measure the reference signal transmitted from each network device, to determine the path difference of signals from the terminal device to different network devices. The intersection point of the hyperbolas formed by more than two unrelated path difference results is the positioning result. If two base stations are not time-synchronized, the calculation result of the signal path difference between the terminal and the two base stations will contain a value that is proportional to the degree of time asynchrony between the two base stations, causing a positioning result deviation.

FIG. 2 is an example diagram of a TDOA positioning method. Referring to FIG. 2, d1, d2, d3, and d4 correspond to paths between a network device 1 to a network device 4 and a terminal device 210, respectively. d4-d1, d4-d3, d3-d2, and d2-d1 correspond to different hyperbolas, and the intersection point of the hyperbolas is the position of the terminal. It may be seen that at least two hyperbolas, i.e., three network devices are needed for the positioning of the terminal device.

AOA/azimuth of departure (AOD) positioning uses antenna arrays at the transmitting end and the receiving end to measure the angle of arrival/departure of the signal, thereby acquiring the angle information between the terminal device and the network device. Then, different straight lines are drawn using orientation information from the terminal device to different network devices, and the intersection area of the straight lines is the estimated position of the terminal device.

### Radio Resource Control (RRC) State and Mobility Management

At present, three RRC states of the terminal device: RRC connected (RRC_connected) state, RRC idle (RRC-idle) state, and RRC inactive (RRC-inactive) state, are defined in protocols.

The RRC_connected state may refer to a state of the terminal device after completing a random access process but not performing RRC release. The RRC connection exists between the terminal device and the network device (e.g., the access network device). In the RRC connected state, the terminal device may perform a data transmission (e.g., a downlink data transmission and/or an uplink data transmission) with the network device. Alternatively, the terminal device may also perform a transmission of a terminal device-specific data channel and/or control channel, with the network device, to transmit specific information or unicast information of the terminal device.

In the RRC_connected state, the network device may determine cell-level position information of the terminal device, that is, the network device may determine a cell to which the terminal device belongs. In the RRC_connected state, after the terminal device moves, such as moving from one cell to another cell, the network device may control the terminal device to perform cell handover. It can be seen that the mobility management for the terminal device in the RRC_connected state may include cell handover. In addition, the mobility management for the terminal device in the RRC_connected state may be controlled by the network device, and accordingly, the terminal device may hand over to a specified cell according to an instruction delivered by the network device.

The RRC-idle state refers to a state of the terminal device when the terminal device resides in the cell but does not perform random access. The terminal device usually enters the RRC-idle state after being powered on or after releasing RRC. In the RRC-idle state, there is no RRC connection between the terminal device and the network device (e.g., a resident network device), the network device does not store the context of the terminal device, and no connection for the terminal device is established between the network device and the core network. If the terminal device needs to enter the RRC connected state from the RRC-idle state, the terminal device needs to initiate the RRC connection establishment process.

In the RRC-idle state, the core network (CN) may transmit a paging message to the terminal device, that is, the paging process may be triggered by the CN. Optionally, the paging area may also be configured by the CN. In some cases, for the terminal device in the RRC-idle state, when the terminal device moves (e.g., moving from one cell to another cell), the terminal device may initiate a cell reselection process. In other cases, for the terminal device in the RRC-idle state, when the terminal device needs to access a cell, the terminal device may initiate a cell selection process. That is, the mobility management for the terminal device in the RRC-idle state may include the cell reselection and/or cell selection.

The RRC-inactive state is a state defined to reduce air interface signaling, quickly restore a wireless connection, and quickly restore a data service. The RRC-inactive state is a state between the RRC_connected state and the RRC-idle state. The terminal device has previously entered the RRC_connected state and then released the RRC connection with the network device, but the network device has stored the context of the terminal device. In addition, the connection established for the terminal device between the network device and the core network is not released, that is, the user plane bearer and control plane bearer between RAN and CN are still maintained, that is, there is a CN-NR connection.

In the RRC-inactive state, the RAN may transmit a paging message to the terminal device, that is, the paging process may be triggered by the RAN. The RAN-based paging area is managed by the RAN, and the network device can know that the position of the terminal device is based on the RAN-level paging area.

In some cases, for the terminal device in the RRC-inactive state, when the terminal device moves (e.g., moving from one cell to another cell), the terminal device may initiate the cell reselection process. In other cases, for the terminal device in the RRC-inactive state, when the terminal device needs to access a cell, the terminal device may initiate a cell selection process. That is, the mobility management for the terminal device in the RRC-inactive state may include cell reselection and/or cell selection.

### Relaxed Radio Resource Management (RRM) Measurement Mechanism

RRM measurement is a type of mobility measurement, and the mobility measurement result may be used for the cell selection, cell handover, and cell reselection. In some implementations, the terminal device in the RRC-inactive state and the terminal device in the RRC-idle state may perform the RRM measurement by receiving and measuring SSBs transmitted from a serving cell and a neighbor cell, to obtain RRM measurement results. In a case where a certain condition is met, the terminal device may perform relaxed RRM measurement (e.g., by reducing measurement on SSBs) to save power consumption.

The protocol (5.2.4.9 in TS 38.304) defines four relaxed measurement criteria, namely for a terminal device not at cell edge, a terminal device with low mobility, a stationary reduced capability (RedCap) terminal device, and a stationary reduced capability terminal device not at cell edge. The above criteria are introduced below.

The low mobility criterion is mainly used to determine whether the terminal device is in a low mobility state. If the terminal device is in the low mobility state, that is, the position of the terminal device is relatively fixed, the terminal device has little demand for cell reselection, and the terminal device may perform the relaxed RRM measurement. If the terminal device is in a high mobility state, that is, the position of the terminal device changes greatly, the terminal device has a greater demand for cell reselection, and the terminal device may not perform the relaxed RRM measurement.

Whether the terminal device is in the low mobility state may be determined based on the RRM measurement results of the serving cell. For example, the terminal device may measure the RRM measurement results of the serving cell at different times. If the RRM measurement results of the serving cell change little at different times, that is, the signal quality of the serving cell is relatively stable, which means that the terminal device is in the low mobility state.

In an implementation, the low mobility criterion may mean that when a change in the reference signal receiving power (RSRP) of the terminal device on the serving cell within a time period TSearchDeltaP is less than SSearchDeltaP, the terminal device is considered to meet the relaxed measurement criterion. That is, within the time period TSearchDeltaP, (SrxlevRef-Srxlev)<SSearchDeltaP (Formula 1) is met. Srxlev represents a current signal amplitude of the serving cell, and SrxlevRef represents a signal amplitude reference value of the serving cell. Generally, the use of SrxlevRef may follow the following rules.

Rule I: After the terminal device performs cell selection or cell reselection, and the serving cell changes, the terminal device needs to set the signal reference value to the current measurement value (i.e., Srxlev) of the signal amplitude of the serving cell.

Rule II: If the signal amplitude of the serving cell is greater than the signal amplitude reference value, that is, (Srxlev-SrxlevRef) is greater than 0, the terminal device needs to set the signal reference value to the current measurement value of the signal amplitude of the serving cell.

Rule III: If the relaxed measurement criterion is not met (i.e., Formula 1 is not met) within the time TSearchDeltaP, the terminal device needs to set the signal reference value to the current measurement value of the signal amplitude of the serving cell.

The not at cell edge criterion is mainly used to determine whether the terminal device is located at the edge cell position of the serving cell. If the terminal device is located not at edge cell position of the serving cell, the terminal device has little demand for cell reselection, and may perform relaxed RRM measurement, to achieve the purpose of power saving for the terminal device. If the terminal device is located at the edge cell position of the serving cell, the terminal device has a greater demand for cell reselection, and the terminal device may not perform relaxed RRM measurement.

The not at cell edge criterion mainly defines an RRM measurement threshold. By comparing the RRM measurement result with the RRM measurement threshold, whether the terminal device is located not at edge cell position may be determined. For example, if the RRM measurement result is greater than the RRM measurement threshold, it indicates that the terminal device is located not at the edge cell position of the serving cell; if the RRM measurement result is less than or equal to the RRM measurement threshold, it indicates that the terminal device is located at the edge cell position of the serving cell.

The not at cell edge criterion is described by taking the RRM measurement result as the RSRP and reference signal receiving quality (RSRQ) as an example. The network device may define two thresholds SSearchThresholdP and SSearchThresholdQ of the not at cell edge criterion, by configuring a cell edge evaluation (cellEdgeEvaluation) parameter to the terminal device. SSearchThresholdP is the measurement threshold value of RSRP, and SSearchThresholdQ is the measurement threshold value of RSRQ. The terminal device may measure the RSRP and RSRQ of the serving cell to obtain the measurement value of the RSRP and the measurement value of the RSRQ of the serving cell. When the measurement value of the RSRP of the serving cell (e.g., the current signal amplitude Srxlev of the serving cell) is greater than SSearchThresholdP (Srxlev>SSearchThresholdP, that is, Formula 2), and the measurement value of the RSRQ (e.g., the current signal strength Squal of the serving cell) is greater than SSearchThresholdQ (Squal>SSearchThresholdQ, that is, Formula 3), the terminal device meets the not at cell edge criterion and the terminal device may perform relaxed RRM measurement.

Of course, the network device may also configure only one parameter of SSearchThresholdP and SSearchThresholdQ. For example, the network device may only configure SSearchThresholdP but not configure SSearchThresholdQ, and in this case, the terminal device may only measure the RSRP of the serving cell. When the measurement value of the RSRP of the serving cell is greater than SSearchThresholdP, the terminal device meets the not at cell edge criterion and the terminal device may perform relaxed RRM measurement. For another example, the network device may only configure SSearchThresholdQ but not configure SSearchThresholdP, and in this case, the terminal device may only measure the RSRQ of the serving cell. In a case where the measurement value of the RSRQ of the serving cell is greater than SSearchThresholdQ, the terminal device meets the not at cell edge criterion and the terminal device may perform relaxed RRM measurement.

The stationary reduced capability terminal criterion may refer to (SrxlevRefStationary−Srxlev)<SSearchDeltaP-Stationary (Formula 4), where Srxlev may represent the signal amplitude of the current serving cell, and SrxlevRefStationary may represent the reference value of the signal amplitude of the current serving cell.

Generally, the use of SrxlevRefStationary may follow the following rules.

Rule I: After the terminal device performs cell selection or cell reselection, the serving cell changes, the terminal device needs to set the signal reference value to the current measurement value of the signal amplitude of the serving cell (i.e., Srxlev).

Rule II: If the signal amplitude of the serving cell is greater than the signal amplitude reference value, that is, (Srxlev-SrxlevRefStationary) is greater than 0, the terminal device needs to set the signal reference value to the current measurement value of the signal amplitude of the serving cell.

Rule III: If the relaxed measurement criterion is not met within the time TSearchDeltaP-Stationary (i.e., Formula 4 is not met), the terminal device needs to set the signal reference value to the current measurement value of the signal amplitude of the serving cell.

In some embodiments, the relaxed measurement criterion defined in clause 5.2.4.9.3 (the stationary reduced capability terminal not at cell edge criterion) may mean that if Srxlev>SSearchThresholdP2 and Squal>SSearchThresholdQ2 are met within a time period TSearchDeltaP-Stationary, the terminal device may perform relaxed RRM measurement. Srxlev may represent the signal amplitude of the current serving cell, and Squal may represent the signal strength of the current serving cell.

### Low Power High Accuracy Positioning (LPHAP)

Generally, the terminal device in the RRC-inactive state and the terminal device in the RRC-idle state must wake up to receive each positioning reference signal (PRS) indicated by the location management function (LMF), to maintain higher positioning accuracy, however, this results in greater up/ramp-down power consumption.

In some embodiments, the LPHAP terminal device may be in a low mobility state, or located in the center of the cell (e.g., located in a factory area and hardly move or move very little). In this case, it may be assumed that the terminal device rarely changes its position, and therefore, the terminal device does not need to measure a DL-PRS (or transmit an SRS) frequently, thereby achieving the purpose of power saving.

### Delayed Positioning Request

For the terminal device in the RRC-inactive state and the terminal device in RRC-idle state, in a case where the terminal device was previously in the RRC_connected state, the terminal device may be configured with at least one location reporting event. Types of location reporting events may include a periodic event and a triggered event.

For the periodic location reporting event, a location services (LCS) service request may include the time interval between successive location reports and the total number of reports. For area event reporting, the LCS service request includes detail information of the target geographical area, whether the event to be reported is the terminal device being inside the target area, the terminal device entering or leaving the target area, the duration of event reporting, the minimum and maximum time intervals between successive event reports, the maximum event sampling interval, whether location estimates are included in event reportswhether a position estimate (and the location-associated quality of service (QoS)) is included in the event report, and whether only one location report is required or multiple location reports are required. For mobility event reporting, the LCS service request includes the linear distance threshold, the duration of the event report, the minimum and maximum time intervals between successive event reports, the maximum event sampling interval, whether a location estimate (and the position-associated QoS) is included in the event report, and whether only one location report is required or multiple location reports are required.

When one of these events is detected, the terminal device in the RRC-inactive state reports the triggered event to the network device and performs the DL-PRS measurement or SRS transmission.

### Beam Sweeping

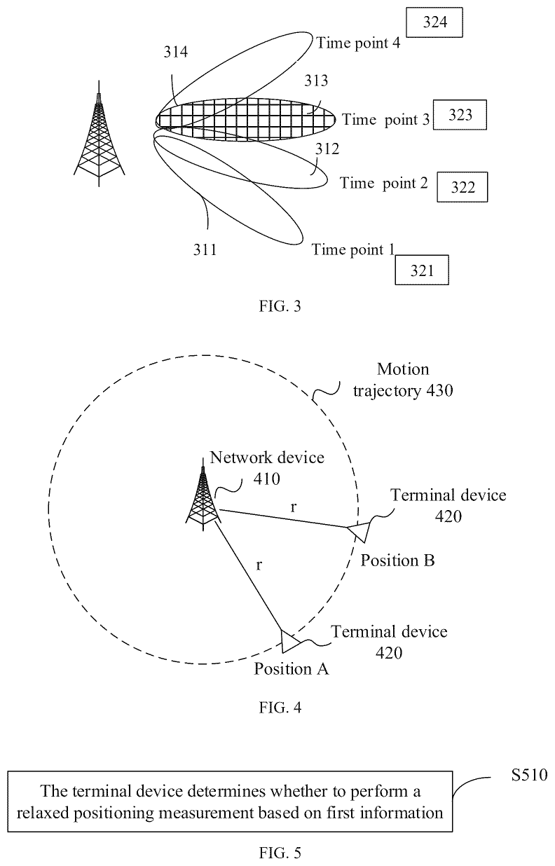

In newer communication systems (e.g., NR), a multi-beam system may be used to cover the entire cell, that is, each beam in the multi-beam system (e.g., beams 311 to 314) covers a smaller range in the cell respectively, and beam sweeping is used to achieve the effect of multiple beams covering the entire cell, as illustrated in FIG. 3.

In the beam sweeping process, different beams are used at different time points to cover different areas in the cell, and for example, at a time point 1, the communication system may cover the area of the terminal device 321 through beam 311. At a time point 2, the communication system may cover the area of the terminal device 322 through beam 312. At a time point 3, the communication system may cover the area of the terminal device 323 through beam 313. At a time point 4, the communication system may cover the area of the terminal device 324 through beam 314.

In order to facilitate the receiving of the terminal devices and increasing the coverage range of a single SSB, each SSB may be transmitted by beamforming. An SSB has an SSB index, and each SSB beam corresponds to an SSB index. In some embodiments, different SSBs within a period may be allocated to different beams for transmissions, the transmission time of each SSB is different, and each beam performs the transmission in sequence, so this method is called SSB beam sweeping, and the SSB beam sweeping is for the entire cell.

That is, the above beams 311 to 314 correspond to different SSB indexes, respectively, and for example, the beams 311 to 314 correspond to SSB0 to SSB3, respectively.

As can be seen from the above, when evaluating the possibility of the relaxed measurement, the main consideration is the cell (signal) quality, such as signal amplitude and signal strength. However, when the signal quality of the cell of the terminal device meets the relaxed measurement criterion, the terminal device may be in a non-low mobility state. An example of the above case is described below with reference to FIG. 4.

Referring to 4, the network device 410 is a network device corresponding to the service cell of the terminal device 420. The terminal device 420 may move along a moving trajectory 430, where the moving trajectory 430 is a circular path around the network device 410. When the terminal device 420 moves from a position A to a position B, the distance between the terminal device 420 and the network device 410 is always r, that is, the distance between the terminal device 420 and the network device 410 remains substantially unchanged. Since the signal quality of the service cell depends to a certain extent on the distance between the network device 410 and the terminal device 420, when the distance between the network device 410 and the terminal device 420 remains basically unchanged, it may be considered that the signal quality of the service cell of the terminal device 420 remains basically unchanged.

In this case, if the determination for the relaxed positioning measurement is performed, the signal quality of the cell of the terminal device 420 may meet the low mobility criterion, and the relaxed positioning measurement may be performed. However, as can be seen from FIG. 4, the terminal device 420 is actually not in a low mobility state, and in this case, if the relaxed positioning measurement is performed on the terminal device 420, a certain error will be introduced.

In order to solve the above problems, the embodiments of the present disclosure provide a method for wireless communication, which determines whether relaxed positioning measurement may be performed based on the signal quality of the synchronization signal block of the serving cell and/or the signal quality of the neighbor cell (i.e., the first information). Since the synchronization signal block is transmitted through beamforming and has a certain directionality, the determination result of the terminal device mobility may be refined; in this case, the mobility state of the terminal device is determined by using the signal qualities of multiple cells jointly, which helps to improve the accuracy of the determination result and thus helps to improve the reliability of the relaxed measurement. The communication method in the embodiments of the present disclosure is described in conjunction with FIG. 5.

FIG. 5 is a schematic flowchart of a method for wireless communication in the embodiments of the present disclosure. The method illustrated in FIG. 5 includes step S510.

In step S510, the terminal device determines whether to perform relaxed positioning measurement based on first information.

Based on the previous description, it can be seen that the terminal device determining whether to perform the relaxed positioning measurement based on the first information, may be replaced such that the terminal device determines the state of the terminal device, such as mobility state, position state, based on the first information, to determine whether the terminal device performs the relaxed positioning measurement. The relaxed positioning measurement mentioned here may include, for example, not performing a current positioning measurement, and/or reporting a last positioning measurement result to a network device. The positioning measurement may include DL-PRS measurement and/or SRS transmission.

In some embodiments, the first information may be associated with one or more of: a signal quality of an SSB of a serving cell; or a signal quality of a neighbor cell.

In some embodiments, the first information is associated with the signal quality of the SSB of the serving cell. As mentioned above, each cell may include multiple SSBs, and each SSB may be transmitted by beamforming. Therefore, the first information being associated with the signal quality of the SSB of the service cell, may refine the determination of the state of the terminal device, such as refining the determination of the mobility state of the terminal device, thereby contributing to the accuracy of the determination result.

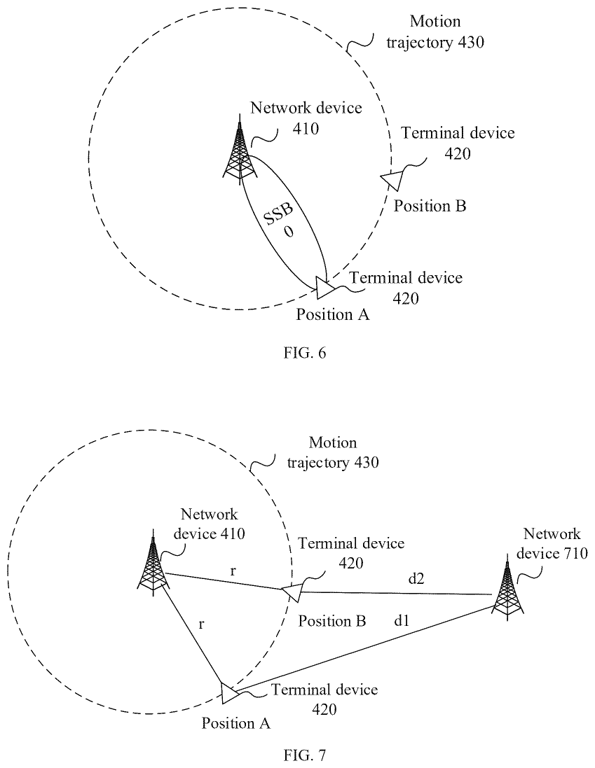

FIG. 6 is an example diagram of a position relationship between the terminal device in FIG. 4 and a SSB0 beam. Referring to FIG. 6, when the terminal device moves from the position A to position B, although the cell-level signal quality of the service cell of the terminal device substantially does not change, the signal quality of SSB0 received by the terminal device changes (that is, the signal quality of SSB0 decreases). That is, in this case, based on the signal quality of SSB0, the accuracy of the determination result of the terminal device mobility may be improved, thereby helping to improve the reliability of relaxed measurement.

In some embodiments, the first information is associated with the signal quality of the SSB of the serving cell and the cell-level signal quality of the serving cell. Determining the mobility state of the terminal device by combining the cell-level signal quality and the SSB signal quality of the serving cell, helps to further improve the accuracy of the determination result.

In some embodiments, the first information is associated with the signal quality of the neighbor cell. For example, the first information may be associated with the signal quality of the neighbor cell and the signal quality of the serving cell. That is, the terminal device may determine whether to perform the relaxed measurement based on the signal quality of the neighbor cell and the signal quality of the serving cell. Determining the mobility state of the terminal device through the measurement results of multiple cells helps to improve the accuracy of the determination result of the mobility state of the terminal device, thereby helping to improve the accuracy of relaxed measurement.

FIG. 7 is a schematic diagram of a position relationship between the terminal device in FIG. 4, the serving cell, and the neighbor cell. The network device 710 is a network device corresponding to the neighbor cell of the terminal device.

Referring to FIG. 7, in the process of the terminal device moving from the position A to position B, although the signal quality of the serving cell does not change substantially, the signal quality of the neighbor cell changes. As can be seen from FIG. 7, a distance between the position A and the network device 710 is d1, and a distance between the position B and the network device 710 is d2. When the terminal device moves from the position A to position B, the distance between the terminal device and the network device 710 changes from d1 to d2, and the signal quality of the neighbor cell received by the terminal device changes. Based on this, it may be determined that the terminal device is in a non-low mobility state. It can be seen that the accuracy of the determination result of the mobility state of the terminal device may be improved through the signal quality of the neighbor cell, thereby improving the reliability of the relaxed measurement.

It should be noted that the above-mentioned signal quality may refer to RSRP and/or RSRQ.

In some embodiments, the first information may be associated with a change in the signal quality of the SSB of the serving cell, for example, the first information may be associated with the change in the signal quality of the SSB of the serving cell within a first time period. Based on the change in the signal quality of the SSB of the serving cell, the mobility state of the terminal device may be determined, for example, the terminal device is in a low mobility state, or the terminal device is in a non-low mobility state.

In some embodiments, the first information may be associated with one or more of: a first difference value, used to indicate a change in the signal quality of the SSB of the serving cell; a first threshold, being a threshold associated with the change in the signal quality of the SSB of the serving cell; or a first time period, being a time period for determining the change in the signal quality of the SSB of the serving cell.

For example, the above-mentioned first difference may be (Srxlev-SSBRef−Srxlev-SSB), where Srxlev-SSB is the signal quality of the SSB of the serving cell, and Srxlev-SSBRef is a reference value of the signal quality of the SSB of the serving cell.

As an example, if the following Formula 5 is met within the first time period, the terminal device performs the relaxed positioning measurement.

(Srxlev-SSBRef−Srxlev-SSB)<SSearchDeltaP; (Formula 5)

SSearchDeltaP is the first threshold.

That is, if the change in the signal quality of the SSB of the serving cell within the first time period is less than the first threshold, the terminal device performs the relaxed positioning measurement. If the change in the signal quality of the SSB of the serving cell within the first time period is greater than or equal to the first threshold, the terminal device does not perform the relaxed positioning measurement.

In some embodiments, the use of the reference value of the signal quality of the SSB of the serving cell may follow the following rules.

Rule I: After the terminal device performs the cell selection or cell reselection, the serving cell changes, the terminal device needs to set the reference value (i.e., Srxlev-SSBRef) to a current measurement value of the signal amplitude of the serving cell (i.e., Srxlev-SSB).

Rule II: If the signal amplitude of the serving cell is greater than the signal amplitude reference value, that is, (Srxlev-SSB−Srxlev-SSBRef) is greater than 0, the terminal device needs to set the signal reference value to the current measurement value of the signal amplitude of the serving cell.

Rule III: If the relaxed measurement criterion is not met (i.e., Formula 5 is not met) within the first time period, the terminal device needs to set the signal reference value to the current measurement value of the signal amplitude of the serving cell.

In some embodiments, the first information being associated with the signal quality of the SSB of the serving cell, includes: the first information being associated with signal received power of the SSB of the serving cell; and/or the first information being associated with a signal received quality of the SSB of the serving cell.

For example, if the signal received power of the SSB of the serving cell is greater than a second threshold, and/or the signal received quality of the SSB of the serving cell is greater than a third threshold, the terminal device performs the relaxed positioning measurement.

As an example, the first information includes the signal received power of the SSB of the serving cell and/or the signal received quality of the SSB of the serving cell, and if the first information meets one or more of the following formulas, the terminal device performs the relaxed positioning measurement:

Srxlev-SSB>SSearchThresholdP; (Formula 6)

Squal-SSB>SSearchThresholdQ; (Formula 7)

Srxlev-SSB is the signal received power of the SSB of the serving cell, Squal-SSB is the signal received quality of the SSB of the serving cell, SSearchThresholdP is the second threshold, and SSearchThresholdQ is the third threshold.

As mentioned above, the first information may be associated with the signal quality of the SSB of the serving cell and the cell-level signal quality of the serving cell. That is in a case where the signal quality of the SSB of the serving cell meets the above-mentioned relaxed measurement rules (e.g., meets Formula 5 or Formula 6, Formula 7), and the cell-level signal quality of the serving cell meets the relaxed measurement rules mentioned above (e.g., Formula 1 or Formula 2, Formula 3), the terminal device performs the relaxed measurement. Otherwise, the terminal device does not perform the relaxed measurement.

As mentioned above, the first information is associated with the signal quality of the neighbor cell and the signal quality of the serving cell, where the signal quality of the neighbor cell may refer to the cell-level signal quality of the neighbor cell and/or the signal quality of the SSB of the neighbor cell; the signal quality of the serving cell may refer to the cell-level signal quality of the serving cell and/or the signal quality of the SSB of the serving cell. In other words, the first information may be associated with one or more of: the cell-level signal quality of the neighbor cell; the signal quality of the SSB of the neighbor cell; the cell-level signal quality of the serving cell; and the signal quality of the SSB of the serving cell.

In some embodiments, in a case where the signal quality of the serving cell and/or the signal quality of the SSB of the serving cell meets the relaxed measurement rules, and the signal quality of the neighbor cell and/or the signal quality of the SSB of the neighbor cell meets the relaxed measurement rules, the terminal device performs the relaxed positioning measurement.

The relaxed measurement rules for the signal quality of the neighbor cell and/or the signal quality of the SSB of the neighbor cell are similar to the relaxed measurement rules for the serving cell mentioned above. For example, the relaxed measurement rules for the neighbor cells may include that within a certain time period, a change in the signal quality of the neighbor cell/the signal quality of the SSB measured by the terminal device is less than a certain threshold; the signal amplitude of the neighbor cell/the signal amplitude of the SSB measured by the terminal device is greater than a certain threshold, and the signal strength of the neighbor cell/the signal strength of the SSB measured by the terminal device is greater than a certain threshold (if the network device configures relevant thresholds for the signal strength of the neighbor cell).

The signal quality of the serving cell and/or the signal quality of the SSB of the serving cell measured by the terminal device meeting the relaxed measurement rules is the same as those described above, which will not be repeated here for the sake of brevity.

In some embodiments, the first information may be associated with a weighted sum of the signal quality of the neighbor cell and the signal quality of the serving cell, where a weight of the signal quality of the neighbor cell and a weight of the signal quality of the serving cell may be the same or different. The signal quality of the neighbor cell mentioned here may include the cell-level signal quality of the neighbor cell and/or the signal quality of the SSB of the neighbor cell; the signal quality of the serving cell may include the cell-level signal quality of the serving cell and/or the signal quality of the SSB of the serving cell.

Since the signal quality of the neighbor cell may be poor and susceptible to interference, the weight of the signal quality of the serving cell and the weight of the signal quality of the neighbor cell may be different, and by adjusting the weight values, it helps to avoid the influence of the above-mentioned interference on the determination result of the mobility state of the terminal device.

For example, the weight of the signal quality of the neighbor cell is a first weight value, and the weight of the signal quality of the serving cell is a second weight value, where the second weight value is greater than the first weight value. By setting the signal quality of the neighbor cell susceptible to interference to a smaller weight value, it helps to avoid the influence of the interference on the determination result of the state of the terminal device.

In some embodiments, the first weight value and/or the second weight value may be determined based on first predefined information, such as information predefined by a protocol. That is, the first weight value and/or the second weight value may be defined in the protocol.

In some embodiments, the first weight value and/or the second weight value may be determined based on first pre-configuration information. For example, the first weight value and/or the second weight value may be preconfigured by the network device, or in other words, the first pre-configuration information is carried in signaling transmitted from the network device. For another example, the first pre-configuration information is pre-stored in the terminal device, or in other words, the first weight value and/or the second weight value may be pre-stored in the terminal device. As an example, before the terminal device leaves the factory, the first weight value and/or the second weight value may be pre-stored in the terminal device.

It should be noted that the first weight value and/or the second weight value may be determined based on one or more of the above, that is, the first weight value and/or the second weight value may be determined based on the first predefined information and/or the first pre-configuration information.

In some embodiments, if a change in the weighted sum of the signal quality of the neighbor cell and the signal quality of the serving cell is less than a fourth threshold, the terminal device performs the relaxed positioning measurement.

In some embodiments, the signal quality of the neighbor cell mentioned above may include signal qualities of multiple (e.g., N) neighbor cells, to improve the accuracy of the determination result mentioned above. For example, the N neighbor cells are N cells with the best signal quality among multiple neighbor cells.

For example, the number of neighbor cells (i.e., N) may be configured in a relaxed positioning measurement/SRS transmission rule transmitted from the network device. For another example, the terminal device may receive a target neighbor cell list configured by the network device, and for example, the target neighbor cell list may include identifiers of N neighbor cells.

In some embodiments, the above-mentioned N may be determined based on one or more of: second predefined information; or second pre-configuration information. The second pre-configuration information may be carried in signaling transmitted from the network device, and/or the second pre-configuration information may be pre-stored in the terminal device, and for example, the second pre-configuration information is pre-stored in the terminal device before the terminal device leaves the factory.

In some embodiments, the signal quality of the SSB of the serving cell is a signal quality of any one SSB of multiple SSBs associated with the serving cell, and the signal quality of the SSB of the neighbor cell is a signal quality of any one SSB of multiple SSBs associated with the neighbor cell. For example, SSBs of the serving cell include SSB0 to SSB3, and the signal quality of the SSB of the serving cell may be a signal quality of any one SSB among SSB0 to SSB3. For another example, SSBs of the neighbor cell include SSB4 to SSB6, and the signal quality of the neighbor cell may be a signal quality of any one SSB among SSB4 to SSB6.

Based on the position of the terminal device, the signal quality of the SSB of the serving cell may be different. Therefore, the SSB of the serving cell mentioned above may refer to an SSB with the best signal quality among the SSBs of the serving cell, so as to avoid measurement errors caused by poor SSB signals. For example, if SSB2 has the best signal quality among SSB0 to SSB3, the signal quality of the SSB of the serving cell may refer to the signal quality of SSB2; if SSB6 has the best signal quality among SSB4 to SSB6, the signal quality of the SSB of the neighbor cell may refer to the signal quality of SSB6.

In some embodiments, the SSB of the serving cell may be any one or more SSBs among the multiple SSBs associated with the serving cell, or may be one or more SSBs with the best signal quality among the multiple SSBs associated with the serving cell. The SSB of the neighbor cell may be any one or more SSBs among multiple SSBs associated with the neighbor cell, or may be one or more SSBs with the best signal quality among the multiple SSBs of the neighbor cell.

In some embodiments, the method provided in the embodiments of the present disclosure may be applied to a terminal device in the RRC-idle state or in the RRC-inactive state.

It should be noted that the above-mentioned weight values, multiple thresholds, the first time period and the above-mentioned “certain time” may all be configured by the network device.

In the embodiments of the present disclosure, whether the terminal device may perform the relaxed positioning measurement is determined by using the signal measurement result of the neighbor cell or the signal measurement result of the SSB of the serving cell, which may more accurately detect whether a significant position change has occurred in the terminal device, thereby accurately determining whether the terminal device needs to perform the relaxed positioning measurement.

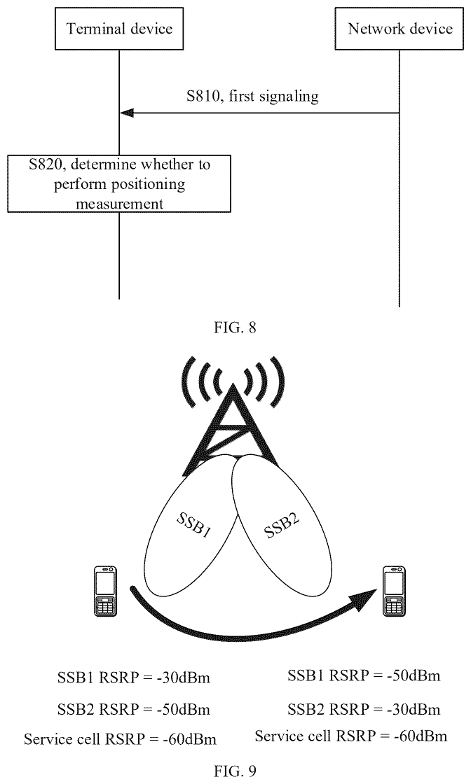

The method provided in the embodiments of the present disclosure is introduced below with reference to FIG. 8 to FIG. 10.

The method illustrated in FIG. 8 includes step S810 and step S820.

In step S810, a terminal device receives first signaling transmitted from a network. The first signaling may include a relaxed positioning measurement criterion and an optional DL-PRS configuration.

In step S820, the terminal device determines whether to perform positioning measurement.

Generally, after entering an inactive-state/idle-state, the terminal device first determines whether performing the positioning measurement is needed, that is, whether measuring the DL-PRS/performing the SRS transmission is needed.

After the aforementioned location reporting event is met, the terminal device determines whether this location reporting event may be skipped, that is, determining whether the relaxed positioning measurement criterion is met.

If the relaxed positioning measurement criterion is met, the terminal device does not perform any action after this triggered event (location reporting event) occurs, or transmits the last available DL-PRS measurement result or positioning result to the network device.

If the relaxed positioning measurement criterion is not met, the terminal device performs the DL-PRS measurement according to the normal procedure, and then transmits the measurement result to the network device, or requests an SRS configuration from the network and performs an SRS transmission.

Taking the first information as the signal quality of the SSB of the serving cell as an example, the method provided in the embodiments of the present disclosure is introduced in combination with FIG. 9.

FIG. 9 is a schematic diagram of a change in the signal quality of the SSB of the serving cell provided in the embodiments of the present disclosure. Two examples of SSB beams, i.e., SSB1 and SSB2, are illustrated in FIG. 9.

Referring to FIG. 9, when the terminal device moves in the direction of the arrow in the figure, the RSRP value of the corresponding service cell does not change, both are −60 dBm, but the RSRP of SSB1 changes from −30 dBm to −50 dBm, and the RSRP of SSB2 changes from −50 dBm to −30 dBm.

In this case, although the cell-level RSRP does not change after the terminal moves, the SSB-level RSRP changes dramatically. Based on the aforementioned relaxed positioning measurement criterion for the SSB of the serving cell, it may be determined that the relaxed positioning measurement criterion is not met, so the terminal device may not start the relaxed positioning measurement.

Taking the first information as the cell-level signal quality of the serving cell and the cell-level signal quality of the neighbor cell as an example, the method provided in the embodiments of the present disclosure is introduced in conjunction with FIG. 10.

FIG. 10 is a schematic diagram of changes in the signal quality of the serving cell and the signal quality of the neighbor cell provided in the embodiments of the present disclosure. FIG. 10 illustrates two examples of neighbor cells, i.e., neighbor cell 1 and neighbor cell 2.

Referring to FIG. 10, when the terminal device moves in the direction of the arrow in the figure, the RSRP value of the corresponding servicing cell does not change, both are −30 dBm, but the RSRP of neighbor cell 1 changes from −40 dBm to −60 dBm, and the RSRP of neighbor cell 2 changes from −60 dBm to −40 dBm.

In this case, although the RSRP of the serving cell does not change after the terminal moves, the RSRP of the neighbor cell changes. Based on the aforementioned relaxed positioning measurement criterion for the neighbor cell, it may be determined that the relaxed positioning measurement criterion is not met, and therefore the terminal device may not start the relaxed positioning measurement.

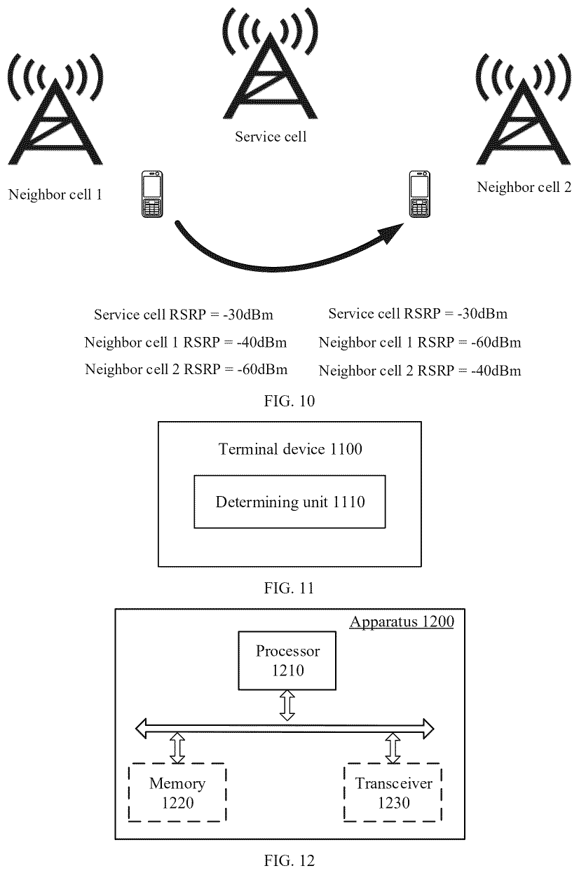

The method embodiments of the present disclosure are described in detail above in conjunction with FIG. 1 to FIG. 10, and the apparatus embodiments of the present disclosure are described in detail below in conjunction with FIG. 11 and FIG. 12. It should be understood that the description of the method embodiments corresponds to the description of the apparatus embodiments, and therefore, for parts that are not described in detail, reference may be made to the previous method embodiments.

FIG. 11 is a schematic diagram of a terminal device in the embodiments of the present disclosure. The terminal device illustrated in FIG. 11 includes: a determining unit 1110.

The determining unit 1110 is configured to determine whether to perform relaxed positioning measurement based on first information; where the first information is associated with one or more of: a signal quality of a synchronization signal block (SSB) of a serving cell; and a signal quality of a neighbor cell.

In some embodiments, the first information being associated with the signal quality of the SSB of the serving cell, includes: the first information being associated with one or more of: a first difference value, used to indicate a change in the signal quality of the SSB of the serving cell; a first threshold, being a threshold associated with the change in the signal quality of the SSB of the serving cell; or a first time period, being a time period for determining the change in the signal quality of the SSB of the serving cell.

In some embodiments, the first difference value is (Srxlev-SSBRef-Srxlev-SSB), where Srxlev-SSB is the signal quality of the SSB of the serving cell, and Srxlev-SSBRef is a reference value of the signal quality of the SSB of the serving cell.

In some embodiments, determining, by the terminal device, whether to perform the relaxed positioning measurement based on the first information, includes: in response that the first difference value within the first time period is less than the first threshold, performing, by the terminal device, the relaxed positioning measurement; or in response that the first difference value within the first time period is greater than or equal to the first threshold, not performing, by the terminal device, the relaxed positioning measurement.

In some embodiments, the first information being associated with the signal quality of the SSB of the serving cell, includes: the first information being associated with signal received power of the SSB of the serving cell; and/or the first information being associated with a signal received quality of the SSB of the serving cell.

In some embodiments, determining whether to perform the relaxed positioning measurement based on the first information, includes: in response that the signal received power of the SSB of the serving cell is greater than a second threshold, and/or the signal received quality of the SSB of the serving cell is greater than a third threshold, performing, by the terminal device, the relaxed positioning measurement.

In some embodiments, the first information is associated with the signal quality of the SSB of the serving cell and a cell-level signal quality of the serving cell.

In some embodiments, the first information is associated with the signal quality of the neighbor cell and a signal quality of the serving cell.

In some embodiments, the first information being associated with the signal quality of the neighbor cell and the signal quality of the serving cell, includes: the first information being associated with one or more of: a cell-level signal quality of the neighbor cell; a signal quality of an SSB of the neighbor cell; a cell-level signal quality of the serving cell; and the signal quality of the SSB of the serving cell.

In some embodiments, the first information is associated with a weighted sum of the signal quality of the neighbor cell and the signal quality of the serving cell.

In some embodiments, determining whether to perform the relaxed positioning measurement based on the first information, includes: in response that a change in the weighted sum of the signal quality of the neighbor cell and the signal quality of the serving cell is less than a fourth threshold, performing, by the terminal device, the relaxed positioning measurement.

In some embodiments, a weight of the signal quality of the neighbor cell is a first weight value, a weight of the signal quality of the serving cell is a second weight value, and the first weight value and/or the second weight value are determined based on one or more of: first predefined information; and first pre-configuration information, where the first pre-configuration information is carried in signaling transmitted from a network device, and/or the first pre-configuration information is pre-stored in the terminal device.

In some embodiments, the signal quality of the neighbor cell includes signal qualities of N neighbor cells.

In some embodiments, the N neighbor cells are N cells with a best signal quality among multiple neighbor cells.

In some embodiments, the signal quality of the SSB of the serving cell is a signal quality of any one SSB of multiple SSBs associated with the serving cell, and a signal quality of an SSB of the neighbor cell is a signal quality of any one SSB of multiple SSBs associated with the neighbor cell.

In some embodiments, the relaxed positioning measurement includes not performing a current positioning measurement and/or reporting a last positioning measurement result to a network device.

In some embodiments, the terminal device is in a radio resource control (RRC) idle state, or the terminal device is in an RRC inactive state.

FIG. 12 is a schematic structural diagram of a communication apparatus in the embodiments of the present disclosure. The dashed lines in FIG. 12 indicate that the unit or module is optional. The apparatus 1200 may be configured to implement the method described in the above method embodiments. The apparatus 1200 may be a chip or a terminal device.

The apparatus 1200 may include one or more processors 1210. The processor 1210 may support the apparatus 1200 to implement the method described in the above method embodiments. The processor 1210 may be a general-purpose processor or a special-purpose processor. For example, the processor may be a central processing unit (CPU). Alternatively, the processor may be other general-purpose processors, digital signal processors (DSPs), application specific integrated circuits (ASICs), field programmable gate arrays (FPGAs) or other programmable logic devices, discrete gate or transistor logic devices, discrete hardware components, etc. The general-purpose processor may be a microprocessor, or the processor may be any traditional processor or the like.

The apparatus 1200 may further include one or more memories 1220. The memory 1220 stores a program, and the program may be executed by the processor 1210, to enable the processor 1210 to perform the method described in the above method embodiments. The memory 1220 may be independent of the processor 1210 or may be integrated into the processor 1210.

The apparatus 1200 may further include a transceiver 1230. The processor 1210 may communicate with other devices or chips through the transceiver 1230. For example, the processor 1210 may transmit and receive data with other devices or chips through the transceiver 1230.

The embodiments of the present disclosure further provide a non-transitory computer-readable storage medium for storing a program. The non-transitory computer-readable storage medium may be applied to the terminal device provided in the embodiments of the present disclosure, and the program enables the computer to perform the methods performed by the terminal device in various embodiments of the present disclosure.

The embodiments of the present disclosure further provide a computer program product. The computer program product includes a program. This computer program product may be applied to the terminal device provided in the embodiments of the present disclosure, and the program enables a computer to perform the methods performed by the terminal device in various embodiments of the present disclosure.

The embodiments of the present disclosure further provide a computer program. The computer program may be applied to the terminal device provided in the embodiments of the present disclosure, and the computer program enables a computer to perform the methods performed by the terminal device in various embodiments of the present disclosure.

It shall be understood that the terms “system” and “network” in the present disclosure may be used interchangeably. Furthermore, the terms used in the present disclosure are only used to explain the exemplary embodiments of the present disclosure, but are not intended to limit the present disclosure. The terms “first,” “second,” “third,” “fourth” and the like in the specification, claims and drawings of the present disclosure are used to distinguish different objects, rather than to describe a specific order. In addition, the terms “include/comprise” and “has/have” and any variations thereof, are intended to cover the non-exclusive inclusion.

In the embodiments of the present disclosure, the “indicate/indicated/indicating/indication” mentioned may be a direct indication, an indirect indication, or may also indicate that there is an associated relationship. For example, A indicating B may mean that A directly indicates B, for example, B may be obtained by A; alternatively, A indicating B may mean that A indirectly indicates B, for example, A indicates C, and B may be obtained by C; alternatively, A indicating B may mean that there is an associated relationship between A and B.

In the embodiments of the present disclosure, “B corresponding to A” means that B is associated with A, and B may be determined according to A. However, it shall also be understood that determining B according to A does not mean determining B based on A only, and B may also be determined based on A and/or other information.

In the embodiments of the present disclosure, the term “correspond/corresponding/correspondence” may indicate a direct correspondence or an indirect correspondence between two items, or may mean that there is an associated relationship between the two items, or may mean a relationship of indicating and being indicated, or a relationship of configuring and being configured, or the like.

In the embodiments of the present disclosure, the “predefined” or “pre-configured” and variations thereof may be implemented by pre-storing corresponding codes, tables or other manners that may be used to indicate related information, in the device (for example, including the terminal device and the network device), and the present disclosure does not limit its specific implementation. For example, the predefined may refer to what is defined in a protocol.

In the embodiments of the present disclosure, the term “protocol” may refer to a standard protocol in the field of communications, and for example, the “protocol” may include an LTE protocol, an NR protocol, and a related protocol used in a future communication system, which is not limited in the present disclosure.

In the embodiments of the present disclosure, the term “and/or” herein is only an association relationship to describe associated objects, indicating that there may be three kinds of relationships, and for example, “A and/or B” may represent three cases where: A exists alone, both A and B exist, and B exist alone. In addition, a character “/” herein generally indicates that the associated objects before and after this character are in an “or” relationship.

In various embodiments of the present disclosure, values of serial numbers of the aforementioned processes do not mean an execution order, and the execution order of each process shall be determined by its function and internal logic, and shall not impose any limitation on the implementation process of the embodiments of the present disclosure.

It shall be understood that the disclosed systems, apparatuses, and methods in several embodiments provided in the present disclosure may be implemented in other modes. For example, the apparatus embodiments described above are merely exemplary, and for example, a division of units is merely a division based on logical functions, while other divisions exist in actual implementations. For example, a plurality of units or components may be combined or integrated into another system, or some features may be omitted or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

All or part of the above embodiments may be implemented by software, hardware, firmware or any combination thereof. When implemented by using software, all or part of the embodiments may be implemented in a form of a computer program product. The computer program product includes one or more computer instructions. When the computer program instructions are loaded and executed on a computer, all or part of the procedures or functions described according to the embodiments of the present disclosure are generated. The computer may be a general-purpose computer, a dedicated-purpose computer, a computer network, or other programmable apparatuses. The computer instructions may be stored in a computer-readable storage medium, or transmitted from a computer-readable storage medium to another computer-readable storage medium. For example, the computer instructions may be transmitted from a website, a computer, a server, or a data center to another website, another computer, another server, or another data center via a wired mode (e.g., a coaxial cable, optical fiber, a digital subscriber line (DSL)) or a wireless mode (e.g., an infrared, radio, microwave, etc.). The computer-readable storage medium may be any available medium that can be read by a computer, or a data storage device including a server or a data center integrated with one or more available media, etc. The available medium may be a magnetic medium (e.g., a floppy disk, a hard disk, a magnetic tape), an optical medium (e.g., a digital video disc (DVD)), or a semiconductor medium (e.g., a solid state disk (SSD)), etc.

The above content is only exemplary implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be determined based on the protection scope of the claims.

What is claimed is:

1. A method for wireless communication, comprising:
determining, by a terminal device, whether to perform relaxed positioning measurement based on first information;
wherein the first information is associated with one or more of:
a signal quality of a synchronization signal block (SSB) of a serving cell; and
a signal quality of a neighbor cell.

2. The method according to claim 1, wherein the first information being associated with the signal quality of the SSB of the serving cell, comprises:
the first information being associated with one or more of:
a first difference value, used to indicate a change in the signal quality of the SSB of the serving cell;
a first threshold, being a threshold associated with the change in the signal quality of the SSB of the serving cell; and
a first time period, being a time period for determining the change in the signal quality of the SSB of the serving cell.

3. The method according to claim 2, wherein the first difference value is (Srxlev-SSBRef−Srxlev-SSB), wherein Srxlev-SSB is the signal quality of the SSB of the serving cell, and Srxlev-SSBRef is a reference value of the signal quality of the SSB of the serving cell.

4. The method according to claim 2, wherein determining, by the terminal device, whether to perform the relaxed positioning measurement based on the first information, comprises:
in response that the first difference value within the first time period is less than the first threshold, performing, by the terminal device, the relaxed positioning measurement; or
in response that the first difference value within the first time period is greater than or equal to the first threshold, not performing, by the terminal device, the relaxed positioning measurement.

5. The method according to claim 1, wherein the first information being associated with the signal quality of the SSB of the serving cell, comprises:
the first information being associated with signal received power of the SSB of the serving cell; and/or
the first information being associated with a signal received quality of the SSB of the serving cell.

6. The method according to claim 5, wherein determining, by the terminal device, whether to perform the relaxed positioning measurement based on the first information, comprises:
in response that the signal received power of the SSB of the serving cell is greater than a second threshold, and/or the signal received quality of the SSB of the serving cell is greater than a third threshold, performing, by the terminal device, the relaxed positioning measurement.

7. The method according to claim 1, wherein the first information is associated with the signal quality of the SSB of the serving cell and a cell-level signal quality of the serving cell; or
the first information is associated with the signal quality of the neighbor cell and a signal quality of the serving cell.

8. The method according to claim 7, wherein the first information being associated with the signal quality of the neighbor cell and the signal quality of the serving cell, comprises:
the first information being associated with one or more of:
a cell-level signal quality of the neighbor cell;
a signal quality of an SSB of the neighbor cell;
a cell-level signal quality of the serving cell; and
the signal quality of the SSB of the serving cell.

9. The method according to claim 7, wherein the first information is associated with a weighted sum of the signal quality of the neighbor cell and the signal quality of the serving cell.

10. The method according to claim 9, wherein determining, by the terminal device, whether to perform the relaxed positioning measurement based on the first information, comprises:
in response that a change in the weighted sum of the signal quality of the neighbor cell and the signal quality of the serving cell is less than a fourth threshold, performing, by the terminal device, the relaxed positioning measurement.

11. The method according to claim 9, wherein a weight of the signal quality of the neighbor cell is a first weight value, a weight of the signal quality of the serving cell is a second weight value, and the first weight value and/or the second weight value are determined based on one or more of:
first predefined information; and
first pre-configuration information, wherein the first pre-configuration information is carried in signaling transmitted from a network device, and/or the first pre-configuration information is pre-stored in the terminal device.

12. The method according to claim 7, wherein the signal quality of the neighbor cell comprises signal qualities of N neighbor cells.

13. The method according to claim 12, wherein the N neighbor cells are N cells with a best signal quality among multiple neighbor cells.

14. The method according to claim 12, wherein N is determined based on one or more of:
second predefined information; and
second pre-configuration information, wherein the second pre-configuration information is carried in signaling transmitted from a network device, and/or the second pre-configuration information is pre-stored in the terminal device.

15. The method according to claim 1, wherein the signal quality of the SSB of the serving cell is a signal quality of any one SSB of multiple SSBs associated with the serving cell, and a signal quality of an SSB of the neighbor cell is a signal quality of any one SSB of multiple SSBs associated with the neighbor cell.

16. The method according to claim 1, wherein the signal quality comprises a reference signal received power (RSRP) and/or a reference signal received quality (RSRQ).

17. The method according to claim 1, wherein the relaxed positioning measurement comprises not performing a current positioning measurement and/or reporting a last positioning measurement result to a network device.

18. The method according to claim 1, wherein the terminal device is in a radio resource control (RRC) idle state, or the terminal device is in an RRC inactive state.

19. A terminal device, comprising a memory and a processor, wherein the memory is configured to store a program, and the processor is configured to call the program in the memory to:
determine whether to perform relaxed positioning measurement based on first information;
wherein the first information is associated with one or more of:
a signal quality of a synchronization signal block (SSB) of a serving cell; and
a signal quality of a neighbor cell.

20. A non-transitory computer-readable storage medium, wherein a program is stored on the non-transitory computer-readable storage medium, and the program enables a computer to:
determine whether to perform relaxed positioning measurement based on first information;
wherein the first information is associated with one or more of:
a signal quality of a synchronization signal block (SSB) of a serving cell; and
a signal quality of a neighbor cell.
